(19) United States
(12) Patent Application Publication
(10) Pub. No.: US 2005/0199352 A1
(43) Pub. Date: Sep. 15, 2005

(54) Window blind

(76) Inventor: Shih-Ming Lin, Chia-Yi Hsien (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 10/798,029

(22) Filed: Mar. 11, 2004

(51) Int. Cl. E06B 9/382

(52) U.S. Cl. 160/178.3

(57) ABSTRACT

A window blind includes a headrail, a bottom rail, a plurality of slats, and a ladder-type slat support. The bottom rail is disposed under the headrail. The slats are disposed one above the other between the headrail and the bottom rail. The of the ladder-type slat support includes first and second side cords, and a plurality of rungs. Each of the first and second side cords has a first end portion that extends into the headrail, a second end portion that is connected removably to the bottom rail, and a middle portion. Each of the rungs supports a respective one of the slats, and has a first end coupled to the middle portion of the first side cord, and a second end coupled removably to the middle portion of the second side cord.

### BACKGROUND OF THE INVENTION

1. Field of the Invention

The invention relates to a window blind, more particularly to a window blind that facilitates easy removal of slats.

2. Description of the Related Art

A conventional window blind includes a hollow horizontal headrail, a bottom rail, a slat unit, a pair of pull ropes, and first and second ladder-type slat supports. The bottom rail is disposed under the hollow horizontal headrail. The slat unit includes a plurality of slats disposed one above the other between the hollow horizontal headrail and the bottom rail. Each of the pull ropes has a first section that extends through the hollow horizontal headrail, a second section that is opposite to the first section and that is connected removably to the bottom rail, and a middle section that interconnects the first and second sections and that passes through the slats. The first sections of the pull ropes are suspended from the hollow horizontal headrail and are connected to a winding mechanism in the hollow horizontal headrail so as to control raising and lowering of the slats.

Each of the first and second ladder-type slat supports includes first and second side cords, and a plurality of rungs. Each of the first and second side cords of the first ladder-type slat support has a first end portion that extends into the hollow horizontal headrail, a second end portion that is opposite to the first end portion and that is connected removably to the bottom rail, and a middle portion that interconnects the first and second end portions of a respective one of the first and second side cords of the first ladder-type slat support. Each of the rungs of the first ladder-type slat support supports a respective one of the slats, and has opposite ends fixed to the middle portions of the first and second side cords of the first ladder-type slat support, respectively.

In a manner similar to that described above in connection with the first ladder-type slat support, each of the first and second side cords of the second ladder-type slat support has a first end portion that extends into the hollow horizontal headrail, a second end portion that is opposite to the first end portion and that is connected removably to the bottom rail, and a middle portion that interconnects the first and second end portions of a respective one of the first and second side cords of the second ladder-type slat support. Each of the rungs of the second ladder-type slat support supports a respective one of the slats, and has opposite ends fixed to the middle portions of the first and second side cords of the second ladder-type slat support, respectively.

The first end portions of the first and second side cords of each of the first and second ladder-type slat supports are connected to a tilt control mechanism in the hollow horizontal headrail so as to adjust tilting angle of the slats.

Although the conventional window blind achieves its intended purpose, since the opposite ends of each of the rungs are connected non-removably to the middle portions of the first and second side cords, removal of the slats is difficult to conduct.

### SUMMARY OF THE INVENTION

Therefore, the object of the present invention is to provide a window blind that can overcome the aforesaid drawback of the prior art.

According to the present invention, a window blind comprises a hollow horizontal headrail, a bottom rail, a slat unit, a pair of pull ropes, and a ladder-type slat support. The bottom rail is disposed under the hollow horizontal headrail. The slat unit includes a plurality of slats disposed one above the other between the hollow horizontal headrail and the bottom rail. Each of the pull ropes has a first section that extends through and that is suspended from the hollow horizontal headrail, a second section that is opposite to the first section and that is connected removably to the bottom rail, and a middle section that interconnects the first and second sections and that passes through the slats. The ladder-type slat support is for supporting the slats, and includes first and second side cords, and a plurality of rungs. Each of the first and second side cords has a first end portion that extends into the hollow horizontal headrail, a second end portion that is opposite to the first end portion and that is connected removably to the bottom rail, and a middle portion that interconnects the first and second end portions. Each of the rungs supports a respective one of the slats, and has a first end coupled to the middle portion of the first side cord, and a second end coupled removably to the middle portion of the second side cord.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic perspective view of the first preferred embodiment of a window blind according to the present invention;

FIG. 2 is a fragmentary, schematic, partly sectional view of the first preferred embodiment to illustrate opposite ends of a rung when connected to side cords of a slat support;

FIG. 3 is a fragmentary, schematic, partly sectional view of the first preferred embodiment to illustrate how a bottom rail is connected to pull ropes and side cords of the slat support;

FIG. 4 is a fragmentary, schematic, partly sectional view of the first preferred embodiment to illustrate how the bottom rail is removed from the pull ropes and the side cords of the slat support;

FIG. 5 is a fragmentary schematic view of the first preferred embodiment to illustrate one of the opposite ends of the rung when disconnected from one of the side cords;

FIG. 6 is a fragmentary schematic perspective view to illustrate first, second, and third connectors of the second preferred embodiment of a window blind according to the present invention;

FIG. 7 is a fragmentary schematic perspective view to illustrate first and second connectors of the third preferred embodiment of a window blind according to the present invention;

FIG. 8 is a fragmentary schematic perspective view to illustrate first and second connectors of the fourth preferred embodiment of a window blind according to the present invention;

FIG. 9 is a fragmentary schematic perspective view to illustrate first and second connectors of the fifth preferred embodiment of a window blind according to the present invention; and

FIG. 10 is a fragmentary schematic perspective view to illustrate first, second, and third connectors of the sixth preferred embodiment of a window blind according to the present invention.

### DETAILED DESCRIPTION OF THE PREFERRED EMBODIMENTS

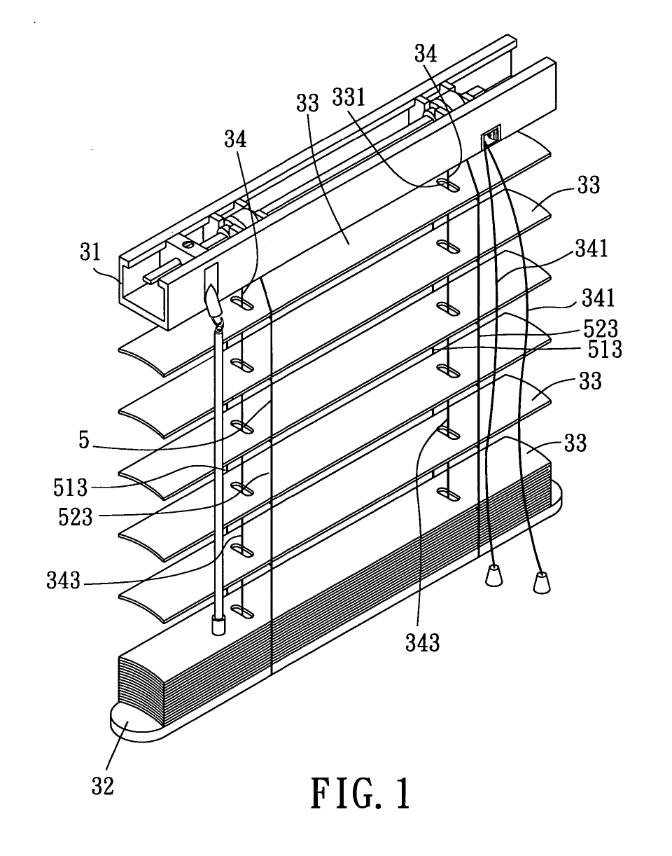

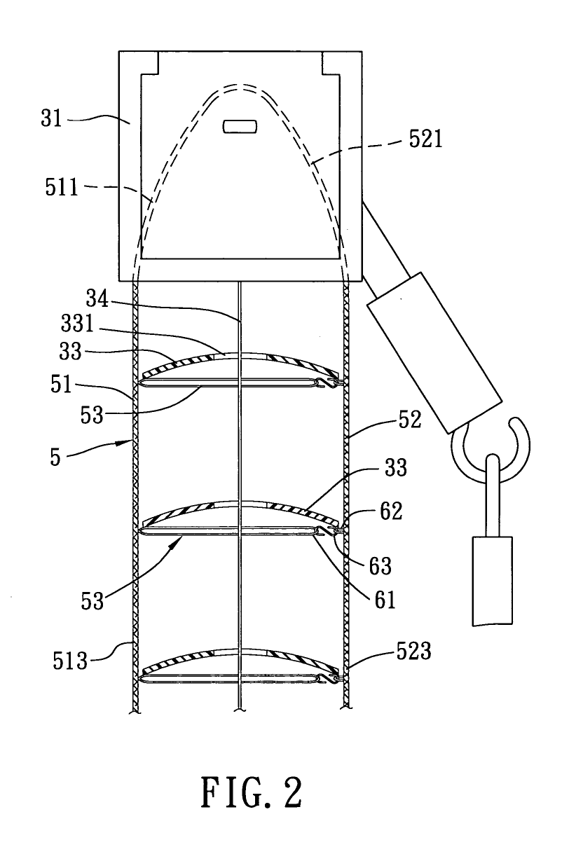

Referring to FIGS. 1 to 3, the preferred embodiment of a window blind according to the present invention is shown to include a hollow horizontal headrail 31, a bottom rail 32, a slat unit, a pair of pull ropes 34, and a pair of ladder-type slat supports 5.

The hollow horizontal headrail 31 is adapted to be mounted on a wall (not shown) above a window (not shown).

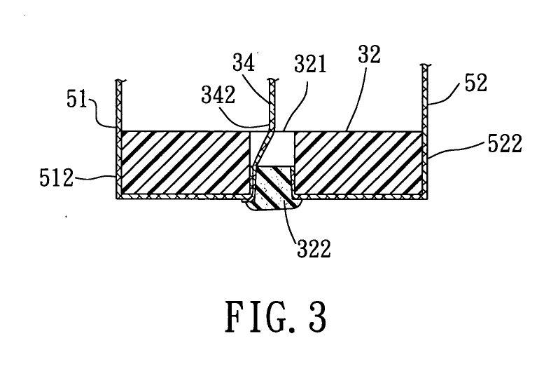

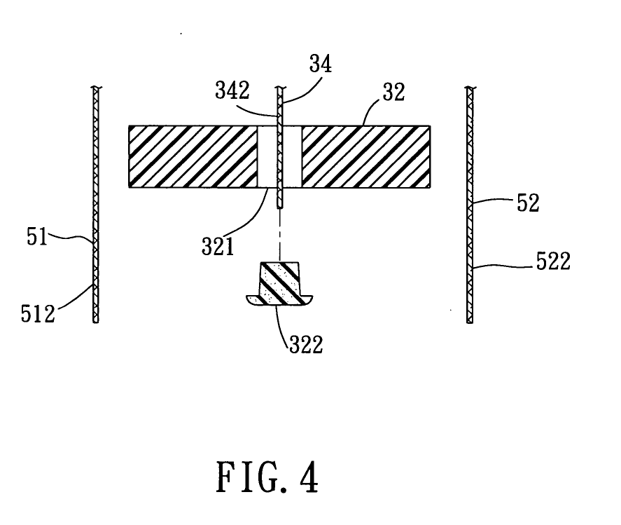

The bottom rail 32 is disposed under the hollow horizontal headrail 31, and is formed with two spaced apart holes 321 (only one of the holes is shown in FIGS. 3 and 4).

The slat unit includes a plurality of slats 33 disposed one above the other between the hollow horizontal headrail 31 and the bottom rail 32. Each of the slats 33 is formed with two spaced apart holes 331.

Each of the pull ropes 34 has a first section 341 that extends through the hollow horizontal headrail 31, a second section 342 that is opposite to the first section 341 and that is connected removably to the bottom rail 32, and a middle section 343 that interconnects the first and second sections 341, 342 and that passes through a respective one of the holes 331 formed in each of the slats 33. It is noted that the first sections 341 of the pull ropes 34 are suspended from the hollow horizontal headrail 31, and are connected to a winding mechanism in the hollow horizontal headrail 31 so as to control raising and lowering of the slats 33 in a manner well known in the art.

Each of the ladder-type slat supports 5 includes first and second side cords 51, 52, and a plurality of rungs 53. Each of the first and second side cords 51, 52 has a first end portion 511, 521 that extends into the hollow horizontal headrail 31, a second end portion 512, 522 that is opposite to the first end portion 511, 521 and that is connected removably to the bottom rail 32, and a middle portion 513, 523 that interconnects the first and second end portions 511, 521, 512, 522. Each of the rungs 53 supports a respective one of the slats 33, and has a first end coupled to the middle portion 513 of the first side cord 51, and a second end coupled removably to the middle portion 523 of the second side cord 52. It is noted that the first end portion 511, 521 of each of the first and second side cords 51, 52 is connected to a tilt control mechanism in the hollow horizontal headrail 31 so as to adjust tilting angle of the slats 33 in a manner well known on the art.

The bottom rail 32 is retained, as shown in FIG. 3, such that the second section 342 of each of the pull ropes 34 is passed through a respective one of the holes 321 formed in the bottom rail 32, such that the second end portions 512, 522 of the first and second side cords 51, 52 of each of the ladder-type slat supports 5 are passed through the respective one of the holes 321 formed in the bottom rail 32, and such that a stopper 322 is plugged in each of the holes 321.

Each of the ladder-type slat supports 5 further includes a plurality of first connectors 61, each of which is provided on the second end of a respective one of the rungs 53, a plurality of second connectors 62 provided on the middle portion 523 of the second side cord 52, and a plurality of third connectors 63, each of which interconnects releasably a respective one of the first connectors 61 and a respective one of the second connectors 62. In this embodiment, the first and second connectors 61, 62 are loops, and the third connectors 63 are S-shaped hooks.

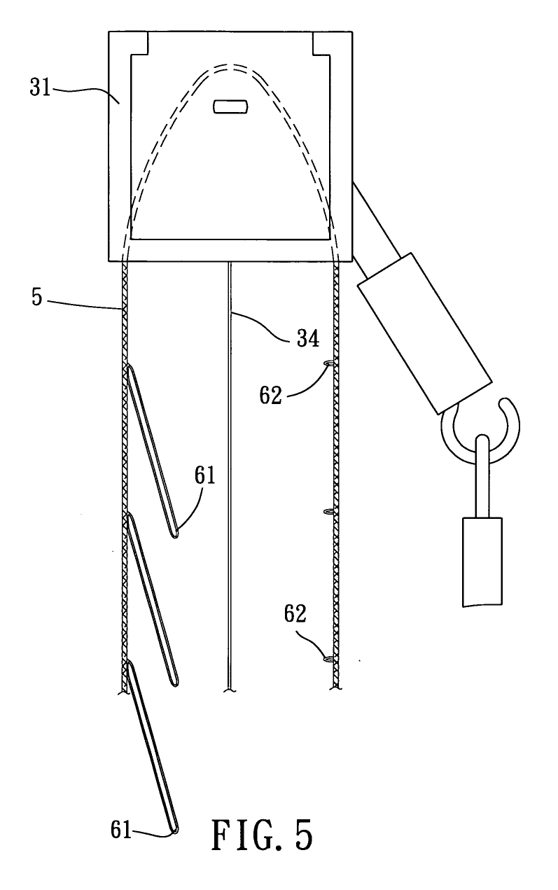

When it is desired to remove the slats 33 for repair or cleaning, the bottom rail 32 is first removed, as best shown in FIG. 4, by unplugging the stoppers 322 from the holes 321 in the bottom rail 32. With the bottom rail 32 removed, the slats 33 can be removed one at a time starting from the lowermost slat 33 by disconnecting the second end of the respective one of the rungs 53 from the middle portion 523 of the second side cord 52, as best shown in FIG. 5. To assemble the slats 33, the procedure for removing the slats 33 is performed in a reversed order.

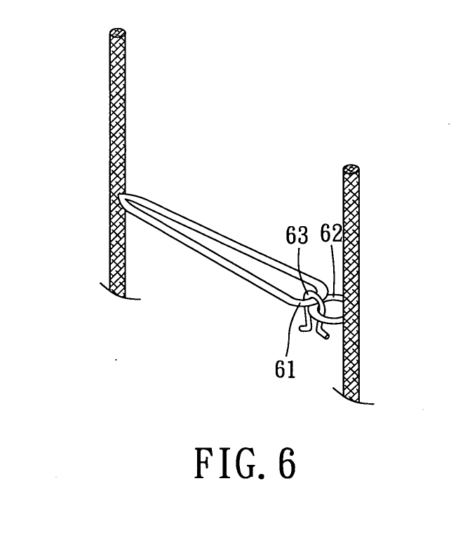

FIG. 6 shows the second preferred embodiment of a window blind according to the present invention. This embodiment differs from the previous embodiment in that the third connectors 63 are U-shaped hooks.

It should be noted herein that the first and second embodiments may be modified by providing the loops directly on one of the rungs 53 and the second side cords 52.

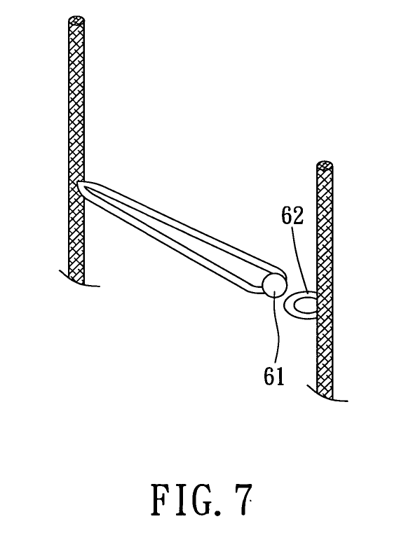

FIG. 7 shows the third preferred embodiment of a window blind according to the present invention. This embodiment differs from the previous embodiments in that the second connectors 62 engage releasably and respectively the first connectors 61, and the third connectors 63 are dispensed with. In this embodiment, each of the first connectors 61 is a ball member, and each of the second connectors 62 is a loop.

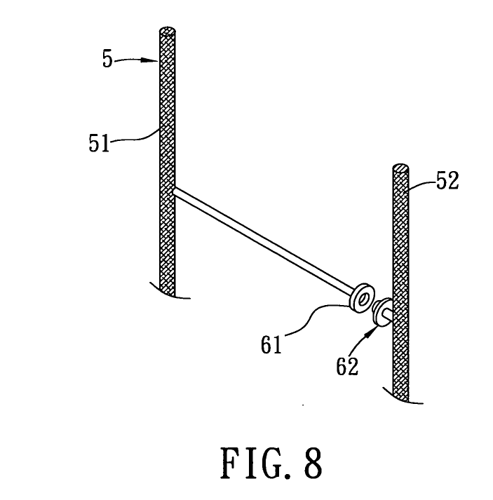

FIG. 8 shows the fourth preferred embodiment of a window blind according to the present invention. This embodiment differs from the third embodiment in that each of the first connectors 61 is a female connector, and that each of the second connectors 62 is a male connector.

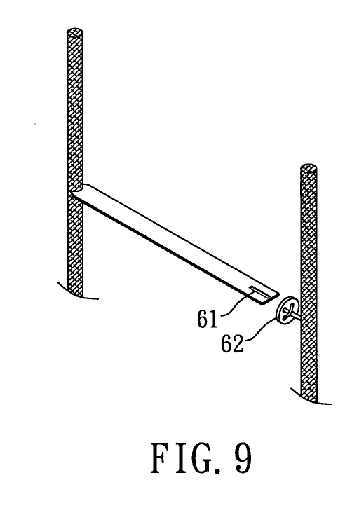

FIG. 9 shows the fifth preferred embodiment of a window blind according to the present invention. This embodiment differs from the third and fourth embodiments in that each of the first connectors 61 is a button hole, and that each of the second connectors 62 is a button.

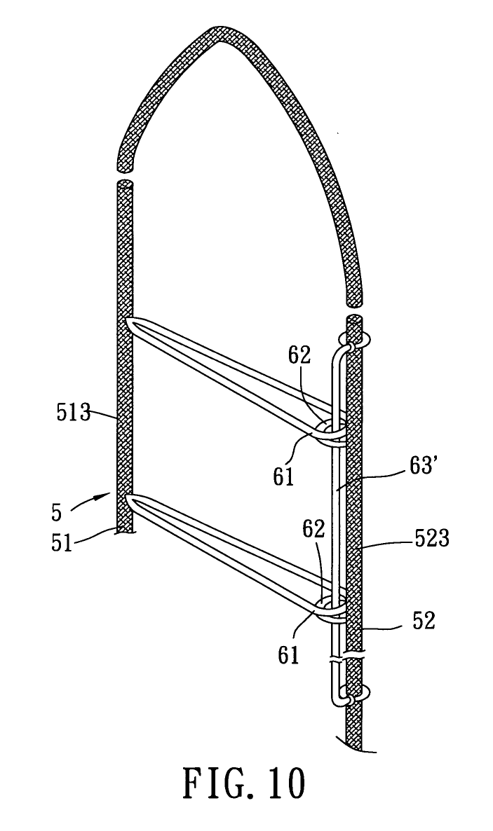

FIG. 10 shows the sixth preferred embodiment of a window blind according to the present invention. This embodiment differs from the first embodiment in that the third connector 63′ is a tie cord that is extended through sets of the first and second connectors 61, 62 and that has opposite ends, at least one of which is connected removably to the middle portion 523 of the second side cord 52.

It has thus been shown that the window blind of the present invention includes a plurality of slats 33, and a pair of ladder-type slat supports 5 for supporting the slats 33 between a hollow horizontal headrail 31 and a bottom rail 32. Each of the ladder-type slat supports 5 includes first and second side cords 51, 52, and a plurality of rungs 53. Each of the rungs 53 has a first end connected to the first side cord 51, and a second end connected removably to the second side cord 52. The construction as such facilitates removal of the slats 33 for repair or cleaning.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A window blind comprising:
a hollow horizontal headrail;
a bottom rail disposed under said hollow horizontal headrail;
a slat unit including a plurality of slats disposed one above the other between said hollow horizontal headrail and said bottom rail;
a pair of pull ropes, each of which has a first section that extends through and that is suspended from said hollow horizontal headrail, a second section that is opposite to said first section and that is connected removably to said bottom rail, and a middle-section that interconnects said first and second sections and that passes through said slats; and
a ladder-type slat support for supporting said slats, including
first and second side cords, each of which has a first end portion that extends into said hollow horizontal headrail, a second end portion that is opposite to said first end portion and that is connected removably to said bottom rail, and a middle portion that interconnects said first and second end portions, and
a plurality of rungs, each of which supports a respective one of said slats, and has a first end coupled to said middle portion of said first side cord, and a second end coupled removably to said middle portion of said second side cord.

2. The window blind as claimed in claim 1, wherein said ladder-type slat support further includes a plurality of first connectors, each of which is provided on said second end of a respective one of said rungs, and a plurality of second connectors provided on said middle portion of said second side cord to engage releasably and respectively said first connectors,
one of said first and second connectors being a loop, the other one of said first and second connectors being a hook.

3. The window blind as claimed in claim 1, wherein said ladder-type slat support further includes a plurality of first connectors, each of which is provided on said second end of a respective one of said rungs, a plurality of second connectors provided on said middle portion of said second side cord, and a plurality of third connectors for interconnecting releasably a respective one of said first connectors and a respective one of said second connectors,
wherein said first and second connectors are loops, and said third connectors are hooks.

4. The window blind as claimed in claim 3, wherein each of said third connectors is S-shaped.

5. The window blind as claimed in claim 3, wherein each of said third connectors is U-shaped.

6. The window blind as claimed in claim 1, wherein said ladder-type slat support further includes a plurality of first connectors, each of which is provided on said second end of a respective one of said rungs, a plurality of second connectors provided on said middle portion of said second side cord, and at least a third connector for engaging releasably a set of said first connectors and a set of said second connectors,
wherein said first and second connectors are loops, and said third connector is a tie cord that is extended through said first and second connectors and that has opposite ends, at least one of which is connected removably to said middle portion of said second side cord.

7. The window blind as claimed in claim 1, wherein said ladder-type slat support further includes a plurality of first connectors, each of which is provided on said second end of a respective one of said rungs, and a plurality of second connectors provided on said middle portion of said second side cord to engage releasably and respectively said first connectors,
one of said first and second connectors being a loop, the other one of said first and second connectors being a ball member.

8. The window blind as claimed in claim 1, wherein said ladder-type slat support further includes a plurality of first connectors, each of which is provided on said second end of a respective one of said rungs, and a plurality of second connectors provided on said middle portion of said second side cord to engage releasably and respectively said first connectors,
one of said first and second connectors being a female connector, the other one of said first and second connectors being a male connector.

9. The window blind as claimed in claim 1, wherein said ladder-type slat support further includes a plurality of first connectors, each of which is provided on said second end of a respective one of said rungs, and a plurality of second connectors provided on said middle portion of said second side cord to engage releasably and respectively said first connectors,
one of said first and second connectors being a button hole, the other one of said first and second connectors being a button.
